(19) United States
(12) Patent Application Publication
(10) Pub. No.: US 2022/0200199 A1
(43) Pub. Date: Jun. 23, 2022

(54) Face-Contact Electrical Connector For Towing

(71) Applicant: Curt Manufacturing, LLC, Eau Claire, WI (US)

(72) Inventors: Curtis M. Bowe, Chippewa Falls, WI (US); Joel D. Diller, Eau Claire, WI (US)

(21) Appl. No.: 17/557,997

(22) Filed: Dec. 21, 2021

Related U.S. Application Data
(60) Provisional application No. 63/128,478, filed on Dec. 21, 2020.

(51) Int. Cl. H01R 13/62; H01R 13/24; H01R 13/631; H01R 43/26

(52) U.S. Cl. CPC H01R 13/6205; H01R 13/2471; H01R 2201/26; H01R 43/26; H01R 13/631

(57) ABSTRACT

A towing electrical connection, for at least four different wires, is made by face contact elements exposed on one side of a housing, such as in an adapter piece having a standard configuration of prongs/sockets on a back side. The adapter piece can be plugged onto the standard electrical plug of a towing vehicle or trailer a single time, leaving the face contact elements exposed for repeated connection and disconnection each time the trailer is connected or disconnected from the towing vehicle. A magnetic attraction force is used to pull and hold the face contact elements in electrical connection, such as by magnets insert molded into a housing of the adapter piece(s) immediately adjacent the exposed face contact elements. A short twisting rotation of the adapter piece about a longitudinal axis is preferably used during connection and disconnection.

### CROSS-REFERENCE TO RELATED APPLICATION(S)

The present application claims priority from U.S. Provisional Application No. 63/128,478 entitled MAGNETIC FACE-CONTACT ELECTRICAL CONNECTOR FOR TOWING filed Dec. 21, 2020, incorporated herein by reference.

### BACKGROUND OF THE INVENTION

The present application relates to towing, and particularly to electrical connectors for detachably connecting electrical systems of towing vehicles and trailers (or other towed loads). Common known towing electrical connectors or plugs include 4-flat, 4 way round, 5-flat, 6-way, 7-pin USCAR, SAE J3008 12 pin, and 13-way connectors. For instance, common 4-flat electrical tow connectors include contacts for:
a) a neutral or ground power wire, typically colored white, electrically connected through to the corresponding terminal of the towing vehicle battery;
b) a tail/running light signal, typically colored brown and powered whenever the towing vehicle headlights or running lights are on;
c) a right turn/brake signal, typically colored green, which can be activated either for timed on-off intervals for a right blinker signal or on continuously whenever the driver steps on the brake pedal of the towing vehicle with the blinker off; and
d) a left turn/brake signal, typically colored yellow, which can be activated either for timed on-off intervals for a left blinker signal or on continuously whenever the driver steps on the brake pedal of the towing vehicle with the blinker off.
   Typically the plug on the towing vehicle has a male prong for the ground power wire and female sockets for each of the tail, right and left signal connections, with the plug on the trailer having a female socket for the ground power wire and male prongs for each of the tail, right and left signal connections. Common 5-flat connectors include an additional contact set for:

e) a brake power signal wire, typically colored blue, indicative of braking or of braking power to be applied to the towed trailer or towed vehicle brakes.

In common seven way electrical tow connections, contact sets are included additionally for:
f) a “hot” power wire, typically colored black or red, connected to the corresponding terminal of the towing vehicle battery; and
g) a reverse or back-up signal, powered whenever the vehicle is in reverse gear.

The traditional male-female interconnect systems used in these connectors require near-perfect prong/socket alignment to ensure a quality connection and minimize damage potential. Over time and use, the male-female prongs and sockets of such electrical connections can bend, corrode or otherwise degrade, making the electrical connection intermittent or ineffective, or requiring difficult or impossible alignment adjustments of the user. With standard towing electrical connections having at least four different wires being connected, even having a single prong or a single socket out of alignment can prevent connection (or disconnection) from being easily achieved.

One potential solution is disclosed in U.S. Pat. No. 6,478,619, incorporated by reference, which discloses a magnetic assisted plug connection using spring loaded pins within first and second sealing mechanisms. However, the solution of U.S. Pat. No. 6,478,619 requires a complicated wiring assembly process including tightening of set screws onto wires, and the set screws and wires move for each connection and disconnection. Better solutions are needed.

### BRIEF SUMMARY OF THE INVENTION

The present invention is an electrical connection for towing which in a sense replaces the sliding relative movement of prongs within sockets with face contact elements which are much more forgiving during connection and disconnection. In many embodiments, the inventive connection is achieved with one or two adapter pieces, which have the face contact elements exposed on one side and have a standard configuration of prongs/sockets on a back side. The adapter piece(s) are plugged onto the standard electrical plug a single time, leaving the face contact elements exposed for repeated connection and disconnection each time the trailer is connected or disconnected from the towing vehicle. A magnetic attraction force is used to pull and hold the face contact elements in electrical connection, such as by magnets insert molded into a housing of the adapter piece(s) immediately adjacent the exposed face contact elements. The preferred housings allow a short twisting rotation of the adapter piece about a longitudinal axis to be used during connection and disconnection.

### BRIEF DESCRIPTION OF THE DRAWINGS

FIG. 1 is a perspective view a two-piece adapter set of the electrical connector present invention, shown relative to an existing towing vehicle 4-flat output plug and an existing trailer 4-flat input plug as ordinarily looking rearwardly.

FIG. 2 is a perspective view of the two-piece adapter set of FIG. 1 assembled onto the output and input plugs, but in a disconnected state, ordinarily as looking forwardly.

FIG. 3 is a perspective view of the two-piece adapter set of FIGS. 1 and 2 assembled onto the output and input plugs, but in a connected state, ordinarily as looking rearwardly.

FIG. 4 is an end view of the trailer side adapter piece of FIGS. 1-3, ordinarily as looking rearwardly.

FIG. 5 is an end view of the towing-vehicle-side adapter piece of FIGS. 1-3, ordinarily as looking forwardly.

FIG. 6 shows a dashed line overlay of the trailer side adapter piece of FIGS. 1-4, rotated for attachment/detachment, on the end view of the towing vehicle side adapter piece of FIG. 5.

FIG. 7 is a perspective view of a second embodiment of the electrical connector of the present invention, in which the trailer-side piece has been incorporated as OEM equipment, but using the towing-vehicle-side adapter piece of FIGS. 1-3 and 5, shown relative to an existing towing vehicle 4-flat output plug as ordinarily looking forwardly.

FIG. 8 is a perspective view of a third embodiment of the electrical connector of the present invention, in which both the trailer-side piece and the towing-vehicle-side piece have been incorporated as OEM equipment, as ordinarily looking rearwardly.

While the above-identified drawing figures set forth preferred embodiments, other embodiments of the present invention are also contemplated, some of which are noted in the discussion. In all cases, this disclosure presents the illustrated embodiments of the present invention by way of representation and not limitation. Numerous other minor modifications and embodiments can be devised by those skilled in the art which fall within the scope and spirit of the principles of this invention.

### DETAILED DESCRIPTION OF THE PREFERRED EMBODIMENTS

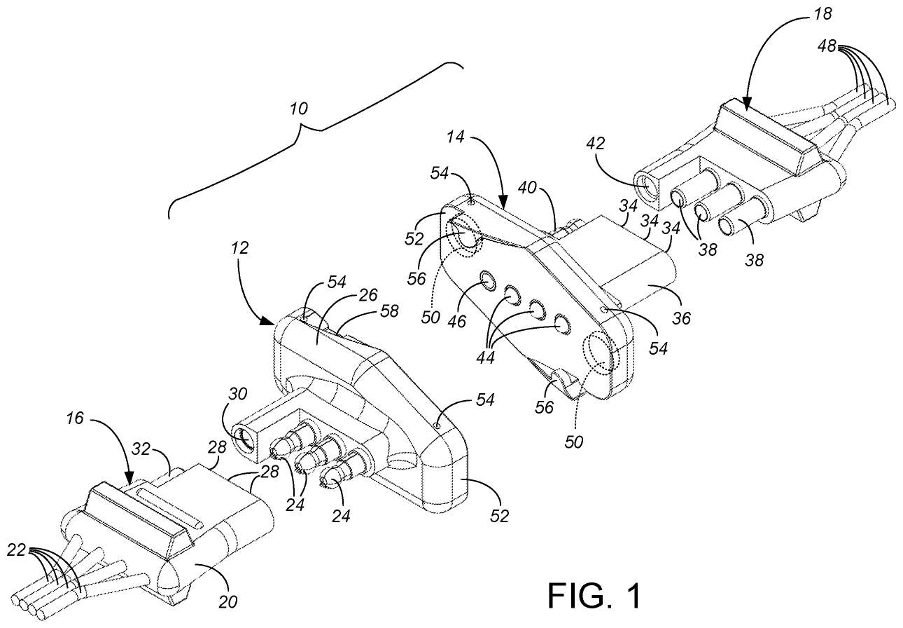

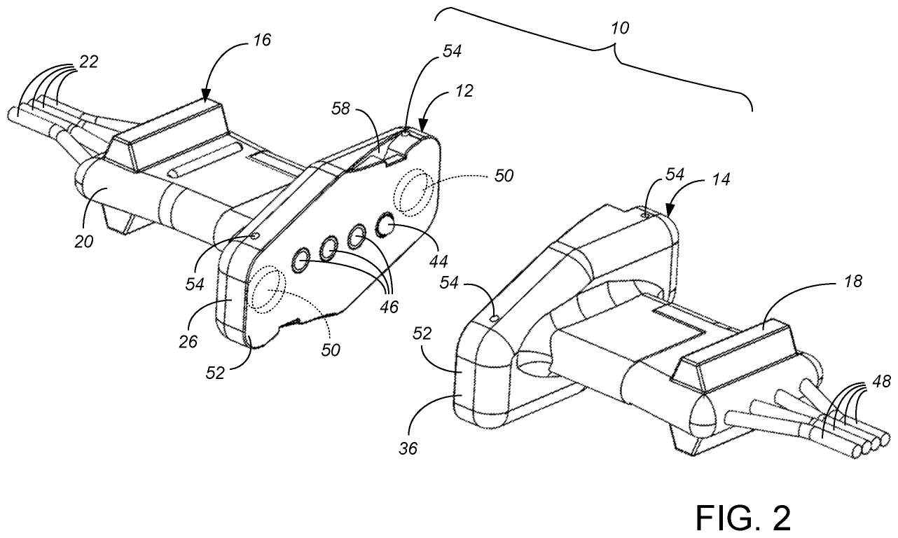

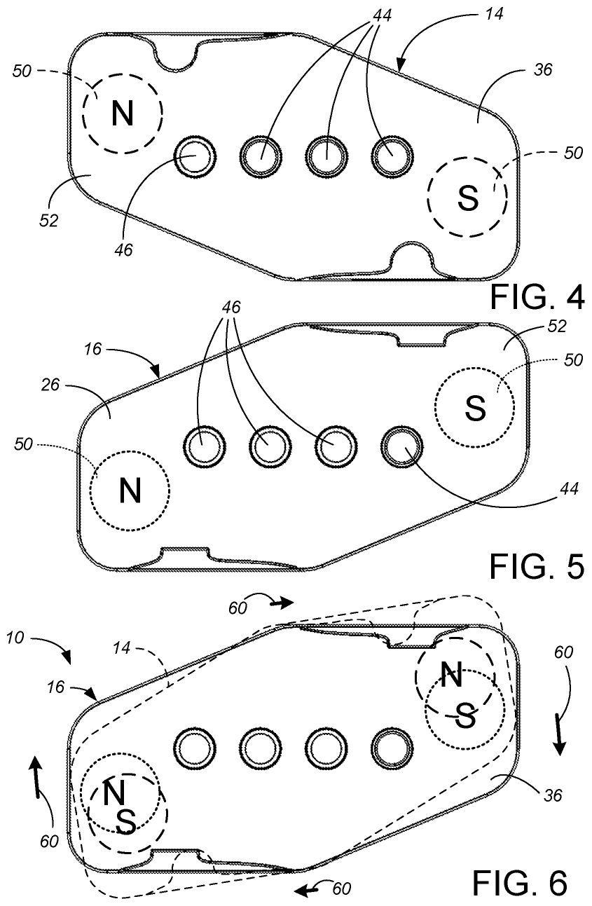

FIGS. 1-6 show an adapter 10 for a 4-flat connector in accordance with a first preferred embodiment the present invention. The adapter 10 includes a towing-vehicle-side adapter plug 12 and a trailer-side adapter plug 14, shown relative to a towing vehicle output plug 16 and a trailer input plug 18 of a standard 4-flat connection. It will be understood that the towing vehicle output plug 16 has an output plug housing 20 which is commonly (but not necessarily) mounted on the towing vehicle (not shown) to face rearwardly. The directional terms “forwardly”, “leading”, “rearwardly”, “trailing”, etc. are used herein in accordance with this common mounting direction, even though it will be understood that wires 22 leading to the towing vehicle output plug 16 are flexible metal conductors within flexible electrically insulative sheaths, and due to this flexibility in use the towing vehicle output plug 16 might face in any direction relative to the forward/rearward direction of travel of the towing vehicle. The trailer input plug 18 includes prongs/sockets which, in the prior art usage without the adapter 10, mate with the sockets/prongs of the towing vehicle output plug 16, allowing electrical connection by longitudinal insertion sliding forwardly of the trailer input plug 18 relative to the towing vehicle output plug 16.

The towing-vehicle-side adapter plug 12, at its leading end, has a male-female 4-flat pin connection sized and configured for attachment to the towing vehicle output plug 16. In particular, the towing-vehicle-side adapter plug 12 includes three male metal prongs 24 extending outside of a molded polymer housing 26 in a longitudinal direction for longitudinal insertion sliding forwardly into the three sockets 28 of the towing vehicle output plug 16, as well as one female metal socket 30 extending within the housing 26 for longitudinal sliding around the exposed male prong 32 of the towing vehicle output plug 16. The prongs 24 and socket 30 are fully stationary relative to the housing 26, so the sliding connection motion can be achieved by the user grasping and pushing the housing 26 forwardly relative to the towing vehicle output plug 16. The trailer-side adapter plug 14, at its trailing end, has a male-female 4-flat pin connection sized and configured for attachment to the trailer input plug 18. In particular, the trailer-side adapter plug 14 includes three female metal sockets 34 extending within its molded polymer housing 36 for longitudinal sliding rearwardly around the three male metal prongs 38 of the trailer input plug 18, as well as one male metal prong 40 extending outside of the housing 36 for longitudinal sliding insertion into the female metal socket 42 of the trailer input plug 18. The sockets 34 and prong 40 are fully stationary relative to the housing 36, so the sliding connection motion can be achieved by the user grasping and pushing the housing 36 forwardly relative to the trailer input plug 18. Thus, both the towing-vehicle-side adapter plug 12 and the trailer-side adapter plug 14 include four sockets/prongs 24, 30, 34, 40 in a standard towing electrical configuration which can make male-female pin connections by first coming into contact with corresponding sets of prongs and sockets 28, 32, 38, 42 and then sliding relative movement in the longitudinal direction. While the connection is made, each socket 28, 30, 34, 42 presses inwardly on the corresponding prong 24, 32, 38, 40 as known in the art.

At the interface between the two adapter plugs 12, 14, four spring loaded electrical face contact pins (a/k/a “pogo pins”) 44, each formed of metal, are used opposite four corresponding stationary face contact pads 46 also formed of metal, making face contact and electrical connections therebetween when attached together. Each pin 44 or pad 46 is electrically connected within its housing 26 or 36 to its correspondingly aligned prong 24 or 40 or socket 30 or 34.

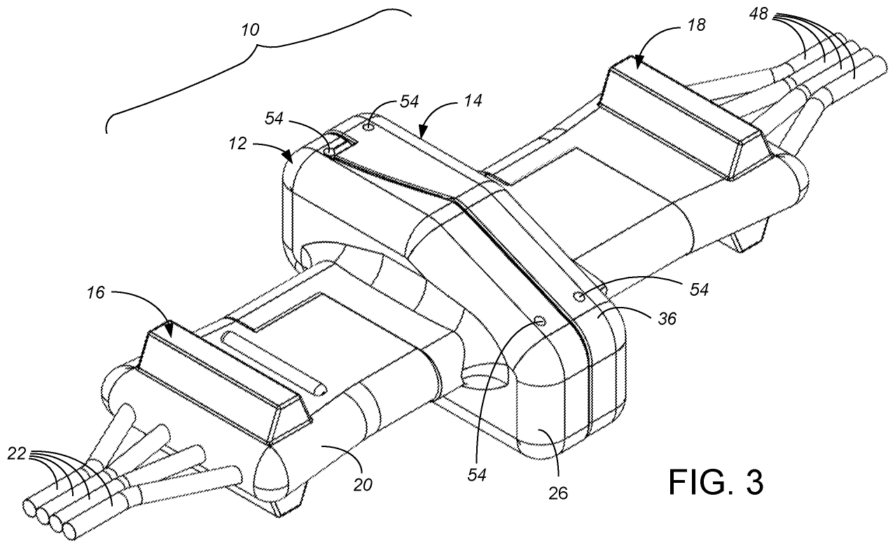

Standard spring loaded face contact pins 44 and stationary face contact pads 46, formed of gold over nickel plated brass but allowing a wire connection on their back end, could be obtained from Shenzhen Czx Hardware Electronics Co. Ltd. of Shenzhen, China. The face contact pins 44 and pads 46 of the preferred embodiment require adaptation from standard face contact pins and pads, so the back side of the pins 44/pads 46 is either a male prong 24 or 40 or a female socket 30 or 34 in accordance with the standard 4-flat connection. The preferred spring loaded electrical face contact pins 44 can easily retract a longitudinal distance of about 2 to 5 mm against the internal spring force. It will thus be understood that, when connected as shown in FIG. 3, each wire 22, 48 completes its electrical connection, first from the output plug 16 to the towing-vehicle-side adapter 12 through a male/female prong/socket connection, then from the towing-vehicle-side adapter 12 to the trailer-side adapter 14 through a face contact pin/pad connection, and then from the trailer-side adapter piece 14 to the input plug 18 through a male/female prong/socket connection. The wires 22, 48 are depicted in the drawings only for a few inches or centimeters out of the output plug 16 and the input plug 18, but can extend for as long as desired within the towing vehicle or trailer. Each of these connections supports a minimum of about 10 A of current and a minimum of about 12 V of electrical potential, insulated through the housing 26, 36 and relative to each of the other three connections.

In the preferred embodiment, the arrangement of spring-loaded pins 44 versus stationary pads 46 mirrors the male/female arrangement of a standard 4-flat, with one of the adapter plugs 14 having three spring-loaded pins 44 and a single stationary pad 46, and the other adapter plug 12 having three stationary pads 46 and one spring-loaded pin 44. As a first alternative, one of the adapter plugs could have four spring-loaded pins (such as one with a female socket back end and three with a male prong back end, to be one-time-pluggable relative to the existing towing-vehicle 4-flat 16) and the other adapter plug could have four stationary pads (one with a male prong back end and three with a female socket back end, to be one-time-pluggable relative to the existing trailer 4-flat 18). As a second alternative, each adapter plug could have two spring-loaded pins and two stationary pads. However, the preferred embodiment, in which every spring-loaded pin 44 has a female socket back end 30 or 34 (four total for the adapter 10) and every stationary pad 46 has a male prong back end 24 or 40 (four total for the adapter 10), requires fewer distinct parts during insert molding manufacture.

In use, the towing-vehicle-side adapter 12 can be plugged into the output plug 16 a single time, and the trailer-side adapter piece 14 can be plugged into the input plug 18 a single time, while the interface between the two adapter pieces 12, 14 can be connected and disconnected multiple times (including hundreds or thousands of times) each time the trailer is hitched to or unhitched from the towing vehicle. Because the spring-loaded pins 44 mate with opposing pads 46 without any sliding of prongs in sockets, there is more offset tolerance during manufacture. There is also much more alignment tolerance when the user makes the electrical connection, which speeds up attaching a trailer to a towing vehicle and reduces the likelihood of damage.

Magnets 50 are preferably used to hold the face contact connection closed. In particular, the preferred embodiment includes four disc magnets 50 (shown in dashed lines in FIGS. 1, 2, 4-6) insert molded, two into side flanges 52 of each housing 26, 36. Each housing 26 includes openings 54 used for holding the magnets 50 in position during the insert molding process. The magnets 50 are mounted with their north and south poles to attract the trailer-side adapter piece 14 to the towing-vehicle-side adapter piece 12. The magnets 50 are also mounted so the attraction force maintains the orientation of the four separate signal wires 22, 48 i.e., so if one of the adapter plugs 12, 14 is rotated 180° about its longitudinal axis, then the magnets 50 will repel against connecting.

With two sets of magnets 50 embedded within the plastic, the sum of magnetic attraction forces (at the distance of separation required by the molded plastic) should be equal to the sum of four spring forces in the pogo pins 44 plus the pull force necessary to separate a standard mechanical male-female 4-flat connector pull out. The most preferred magnets 50 are P125AF-N42 nickel (Ni—Cu—Ni) plated Neodymium (NdFeB) or similar rare earth magnets 50, each about ½ inch (12 mm) in diameter and ⅛ inch (3 mm) in width, with the preferred embedded depth of the magnets 50 beneath each contact face of the molded plastic housings 26, 36 being about 0.025 inches (0.6 mm). Alternatively, other types, sizes or shapes of magnets, or other numbers of magnet pairs, can be used. For instance, another preferred embodiment locates two magnets within the plastic of each plug portion, one over the line of face contact pins 44/pads 46 and one under the line of face contact pins 44/pads 46, with each magnet having dimensions of 0.125×0.125×0.75 inches (3×3×19 mm).

The preferred adapter plugs 12, 14 also include an interlock feature, in the preferred embodiment including a pair of tabs 56 on the housing 36 of the trailer-side adapter piece 14 which rotationally slide into a pair of recesses 58 in the housing 26 of the towing-vehicle-side adapter piece 12. The interlock should occur over a rotational twist angle which is less than about 180°, so it can be achieved by the user by wrist movement with one adapter plug 12 or 14 in one hand the and the other adapter plug 14 or 12 in the other hand and without releasing the grasp of either hand on its adapter plug 12, 14. More preferably, the interlock should occur over a rotational twist angle which is less than about 30°, so magnetic attraction between the magnets 50 can cause the force which self-induces the twisting action. In the preferred embodiment, the interlock occurs over a rotational twist angle of about 9°, shown by arrows 60 and the rotational displacement of adapter piece 14 in FIG. 6. In disconnecting, the attractive force between the magnets 50 is much more easily broken by first twisting one of the adapter plugs 12 or 14 this rotation twist angle (or more) relative to the other adapter plug 14 or 12 rather than simply pulling the adapter plugs 12, 14 longitudinally apart while the magnets 50 are aligned. The interlock feature helps to visually reinforce for the user that disconnection is best achieved by a small twist prior to longitudinally pulling the two adapter plugs 12, 14 apart. The interlock feature also gives a visual indicator that the adapter plugs 12, 14 are in the proper orientation and also help establish and lock in a stable connection.

If desired, each stationary pad 46 could be encircled by its own protruded circular molded seal, whereas each spring-loaded pin 44 could be encircled by a sunken circular molded seal. Such molded seals help to prevent debris and liquids from interfering with the connections when seated. Further, such seals should be sized relative to each other so as to have a negligible friction force during separation, i.e., substantially all of the force holding the two adapter portions 12, 14 together should be provided by magnetic attraction. However, the preferred embodiment shown omits such molded seals in favor of having a flat, planar interface between the two housings 26, 36 allowing the user to more easily perform twisting to overcome the magnetic attraction between the magnet sets.

The molded portions 26, 36 could also include molded female and male alignment features which allow straight pull separation in the longitudinal direction, but positively interfere to prevent rotational motion between the two molded portions 26, 36 about a longitudinal pull axis as long as the two molded portions 26, 36 are close enough together. Such longitudinal alignment features can be arranged around the periphery of the molded portions and most preferably off the ends of each magnet, with male-female orientations that only allow one orientation of connection about the longitudinal pull axis. Such longitudinal alignment features can greatly reduce the likelihood of inadvertent separation through a twisting force, which could otherwise overcome the magnetic attraction force. However, the preferred embodiment shown omits such longitudinal alignment features in favor of allowing the user to perform twisting to more easily overcome the magnetic attraction between the magnet sets.

The adapter 10 including two adapter plug portions 12, 14 is a consumer-purchased product, installable by the user without performing any wiring operations, and instead performing two one-time-only plug-ins. The user merely plugs the leading side of the towing-vehicle-side adapter plug 12 onto the existing 4-flat 16 of the towing vehicle, and plugs the back side of the other trailer-side adapter plug 14 onto the existing 4-flat 18 of the trailer. Thereafter, the standard 4-flat plugging/unplugging connection has been replaced with a magnetic connection/disconnection interface. With this face contact adapter concept, the user need never perform an unplugging operation, and longitudinal sliding of prongs within sockets is never again necessary.

The adapter concept could alternatively be applied to other types of trailer electrical plug connections, such as 4 way round, 5-flat, 6-way, 7-pin USCAR, SAE J3008 12 pin, and 13-way connectors. As used herein, the depicted 4-flat configuration and each of these other known types of trailer electrical plug connections, are considered “standard” towing electrical configurations which make male-female pin connections by first making contact with corresponding sets of prongs and sockets and then sliding relative movement in the longitudinal direction. For each of these standard towing electrical connections, prongs and sockets line up and make contact (whether any side, towing-vehicle-side or trailer side, provides the socket or the prong depends upon the particular configuration, but all of these standard connections use prongs/sockets) and then are slid together through longitudinal movement established by the length and orientation of the prongs/sockets. The important consideration is that the present invention significantly reduces the frequency of the prong/socket sliding over the life of the towing vehicle and/or trailer, instead using a face contact connection without requiring another prong/socket sliding each time the trailer is connected to and disconnected from the towing vehicle.

The magnetic attraction interface between the two adapter portions 12, 14 provides a quick and stable connection, with no chance of bending of pins or prongs and less chance for corrosion. Whenever the user connects the trailer to the towing vehicle, the user merely brings the two adapter portions 12, 14 together in alignment at a slight twist angle and allows the magnet attraction force to draw and twist the two adapter portions 12, 14 together. When disconnecting the trailer from the towing vehicle, the user merely grasps the two molded portions 26, 36, performs a slight twist and pulls them apart with sufficient force to overcome the magnetic attraction. Once the two molded portions 26, 36 are apart, the interface is easy to clean, further minimizing the likelihood of corrosion. The plug-style back ends never need to be unplugged from either the towing vehicle plug 16 or the trailer plug 18, so even if corrosion should occur on the back ends to fuse the plugs (12 and 16, or 14 and 18) together and make unplugging impossible, the two adapter portions 12, 14 can still be separated when needed to disconnect.

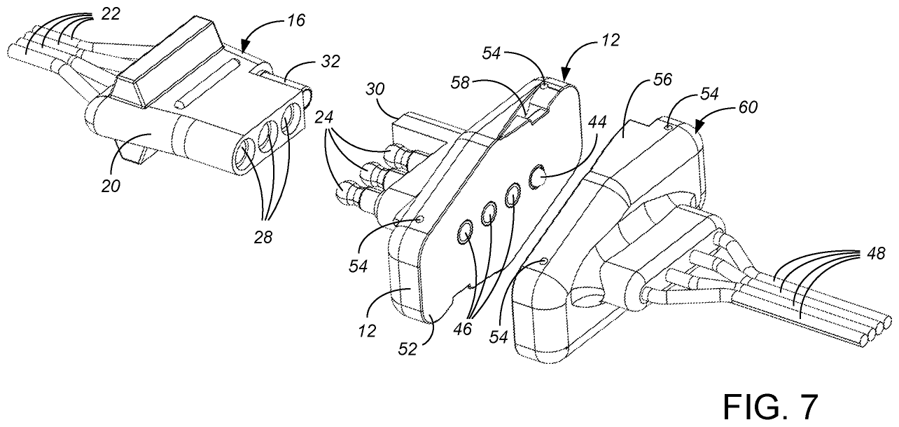

FIG. 7 shows an alternative embodiment, which is half adapter plug. In this case, the OEM trailer manufacturer has hardwired in one of the molded portions 60, and sells the trailer with only one adapter piece 12. The OEM towing vehicle comes with the standard 4-flat plug 16. For first use, the owner plugs the adapter piece 12 onto the towing vehicle 4-flat a single time. Thereafter, the electrical connection is made through the magnet alignment, and disconnection can be made by twisting/pulling the adapter piece 12 apart from the trailer plug 60 (all the while leaving the adapter piece 12 plugged on the towing vehicle 4-flat 16).

An alternative half adapter plug arrangement (not shown) is basically a reversal of the embodiment of FIG. 7. The towing vehicle OEM manufacturer hardwires in its side of the connector, for one-time-plugging of the other adapter plug portion 14 (shown in FIGS. 1-3) to the standard 4-flat input plug 18 (shown in FIGS. 1-3) of the trailer.

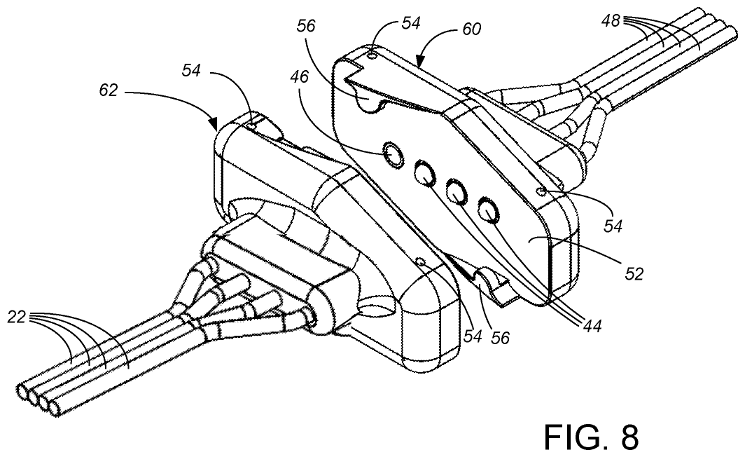

FIG. 8 shows another alternative embodiment, which is an OEM fully hardwired design more similar to that of U.S. Pat. No. 6,478,619, but still incorporating the sealing arrangement and the alignment feature of the preferred adapter embodiment. With both the towing vehicle OEM and the trailer OEM incorporating this design, no plugging or unplugging is ever performed. Connection is made solely by the magnet attraction of magnets within the molded portions 60, 62, and disconnection is accomplished by pulling apart with a pull force that overcomes the magnet attraction.

Although the present invention has been described with reference to preferred embodiments, workers skilled in the art will recognize that changes may be made in form and detail without departing from the spirit and scope of the invention. In particular, all of the dimensions and materials, unless included in the claims, are exemplary only.

1. An electrical connector adapter piece for towing, comprising:
a housing formed of an electrically insulative material, the housing defining a longitudinal direction;
at least four face contact elements formed of metal, which can make readily detachable electrical face contact, each supported by the housing so as to be electrically insulated from each other and exposed on an accessible side of the housing; and
at least four sockets/prongs formed of metal, each electrically connected to one of the at least four face contact elements and supported by the housing, in a standard towing electrical configuration which can make male-female pin connections by first coming into contact with corresponding mating prong/sockets in sets and then sliding relative movement in the longitudinal direction.

2. The electrical connector adapter piece of claim 1, further comprising:
at least one magnet supported by the housing adjacent the at least four face contact elements.

3. The electrical connector adapter piece of claim 2, wherein the housing comprises an interlock feature which allows rotational twisting about a longitudinal axis of the housing for electrical connection to the at least four face contact elements.

4. The electrical connector adapter piece of claim 1, wherein at least one of the at least four face contact elements is a spring loaded electrical face contact pin, which can retract into the housing by overcoming the spring force.

5. An electrical connector for towing, comprising:
a towing-vehicle-side housing formed of an electrically insulative material;
at least four towing-vehicle-side face contact elements formed of metal, each supported by the towing-vehicle-side housing so as to be electrically insulated from each other and exposed on an accessible side of the towing-vehicle-side housing;
a trailer-side housing formed of an electrically insulative material;
at least four trailer-side face contact elements formed of metal, each supported by the trailer-side housing so as to be electrically insulated from each other and exposed on an accessible side of the trailer-side housing; and
at least a first magnet supported by either the towing-vehicle-side housing or the trailer-side housing, providing a magnetic force which can hold the four trailer-side contact elements in electrical contact with the four towing-vehicle-side face contact elements.

6. The electrical connector of claim 5, wherein the first magnet is supported by the towing-vehicle-side housing, and further comprising:
a second magnet supported by the towing-vehicle-side housing;
a third magnet supported by the trailer-side housing, in a position corresponding to the first magnet when the four trailer-side contact elements are in electrical contact with the four towing-vehicle-side face contact elements; and.
a fourth magnet supported by the trailer-side housing, in a position corresponding to the second magnet when the four trailer-side contact elements are in electrical contact with the four towing-vehicle-side face contact elements;
with the first, second, third and fourth magnets having their poles oriented such that magnetic attraction forces between the first and third magnet and magnetic attraction forces between the second and fourth magnet can hold the four trailer-side contact elements in electrical contact with the four towing-vehicle-side face contact elements.

7. The electrical connector of claim 6, further comprising an interlock feature which allows rotational twisting of the towing-vehicle-side housing relative to the trailer-side housing for electrical connection between the four towing-vehicle-side face contact elements to the at least four trailer-side face contact elements.

8. The electrical connector of claim 7, wherein the interlock feature comprises two tabs on the towing-vehicle-side housing, each tab being sized and positioned to be received by twisting rotation about a longitudinal axis within a corresponding recess on the trailer-side housing.

9. The electrical connector of claim 8, wherein the twisting rotation occurs over a rotational twist angle which is less than about 30°.

10. The electrical connector of claim 5, wherein at least one of the at least four towing-vehicle-side face contact elements is a spring loaded electrical face contact pin, which can retract into the towing-vehicle-side housing by overcoming the spring force.

11. The electrical connector of claim 10, wherein at least one of the at least four trailer-side face contact elements is a spring loaded electrical face contact pin, which can retract into the trailer-side housing by overcoming the spring force.

12. The electrical connector of claim 5, further comprising:
at least four towing-vehicle-side sockets/prongs formed of metal, each electrically connected to one of the at least four towing-vehicle-side face contact elements and supported by the towing-vehicle-side housing, in a standard towing electrical configuration which can make male-female pin connections by first coming into contact with corresponding sets of sockets/prongs and then sliding relative movement in a longitudinal direction.

13. The electrical connector of claim 12, further comprising:
at least four trailer-side sockets/prongs formed of metal, each electrically connected to one of the at least four trailer-side face contact elements and supported by the trailer-side housing, in a standard towing electrical configuration which can make male-female pin connections by first coming into contact with corresponding sets of sockets/prongs and then sliding relative movement in a longitudinal direction.

14. A method of making an electrical connection between a towing vehicle and a trailer, comprising:
making at least four male-female pin electrical connections between a connection adapter piece and a plug of a standard towing electrical connection, the connection adapter piece comprising:
a housing formed of an electrically insulative material, the housing defining a longitudinal direction;
at least four face contact elements formed of metal, which can make readily detachable electrical face contact, each supported by the housing so as to be electrically insulated from each other and exposed on an accessible side of the housing; and
at least four sockets/prongs formed of metal, each electrically connected to one of the at least four face contact elements and supported by the housing, in a standard towing electrical configuration;
wherein the making of the male-female pin electrical connections occurs by first coming into contact with corresponding mating prong/sockets in sets and then sliding relative movement in the longitudinal direction; and
making at least four face contact connections with the at least four face contact elements.

15. The method of claim 14, wherein the connection adapter piece further comprises:
at least one magnet supported by the housing adjacent the at least four face contact elements;
and wherein the at least four face contact connections are held together by magnetic attraction.

16. The method of claim 15, wherein the at least four male-female pin electrical connections are left connected while the at least four face contact connections are repeatedly connected and disconnected.

17. The method of claim 16, wherein the repeated connection and disconnection comprises twisting rotation of the connection adapter piece about a longitudinal axis.

18. The method of claim 17, wherein the twisting rotation occurs over a rotational twist angle which is less than about 180°.

19. The method of claim 18, wherein the twisting rotation results in positioning of a tab within a recess during connection.

20. The method of claim 14, wherein at least one of the at least four face contact elements of the connection adapter piece is a spring loaded electrical face contact pin, which can retract into the housing of the connection adapter piece by overcoming the spring force.
